(19) United States
(12) Patent Application Publication
(10) Pub. No.: US 2017/0318829 A1
(43) Pub. Date: Nov. 9, 2017

(54) Chocolate

(71) Applicant: Meiji Co., Ltd., Tokyo (JP)

(72) Inventors: Goro Misaki, Tokyo (JP); Seiichi Fujiwara, Saitama (JP); Hiroyuki Utsunomiya, Tokyo (JP)

(73) Assignee: Meiji Co., Ltd., Tokyo (JP)

(21) Appl. No.: 15/527,407

(22) PCT Filed: Nov. 20, 2015
(86) PCT No.: PCT/JP2015/082666

§ 371 Date: May 17, 2017

(30) Foreign Application Priority Data
Nov. 21, 2014 (JP) 2014-236304

(51) Int. Cl. A23G 1/32

(52) U.S. Cl. CPC A23G 1/32; A23V 2002/00

(57) ABSTRACT

Disclosed is a chocolate bar containing sucrose palmitate and having a cacao mass content of 35 mass % or more, wherein (i) a sucrose palmitate content is between 0.2 mass % and 0.5 mass % inclusive, and a thickness of the chocolate bar is between 1 mm and 3 mm, inclusive, or (ii) a sucrose palmitate content is between 0.1 mass % and 0.5 mass %, inclusive, and a thickness of the chocolate bar is between 1 mm and 2 mm, inclusive.

### TECHNICAL FIELD

The present invention relates to a high cacao mass content chocolate with a reduced bitterness and astringency.

### BACKGROUND ART

Cacao polyphenol contained in cacao mass is verified to have an antioxidant effect, and thus chocolates produced using the cacao mass as the main ingredient are also expected to provide the same effect. However, the cacao mass has an intense bitterness and astringency. Chocolates having a high cacao mass content increase a cacao polyphenol intake per unit amount and enable an efficient cacao polyphenol intake, however the bitterness and astringency are intensified thereby reducing the palatability.

Patent Literature 1 discloses a technique for producing a cacao mass with a favorable flavor by treating a roasted cacao mass with an oxygen gas to reduce unpleasant components that cause a acridity and astringency. Patent Literature 2 discloses a technique for reducing a bitter-astringent by adding a taste modifier to a chocolate, and describes that a heated product obtained by heating palatinose from 140° C. to 200° C. is the effective component of the taste modifier.

### CITATION LIST

### Patent Literature

Patent Literature 1: Japanese Unexamined Patent Publication No. H3-15344
Patent literature 2: Japanese Unexamined Patent Publication No. 2004-2241

### SUMMARY OF INVENTION

### Technical Problem

An object to be solved by the invention is to reduce the bitterness and astringency of chocolates having a high cacao mass content.

### Solution to Problem

The present inventors conducted extensive studies and have consequently accomplished a technique for reducing the bitterness and astringency by modifying the shape of a chocolate and further adding an emulsifier.

More specifically, the present invention provides the following (1) and (2).

(1) A chocolate bar containing sucrose palmitate and having a cacao mass content of 35 mass % or more, wherein
(i) a sucrose palmitate content is between 0.2 mass % and 0.5 mass %, inclusive, and a thickness of the chocolate bar is between 1 mm and 3 mm, inclusive, or
(ii) a sucrose palmitate content is between 0.1 mass % and 0.5 mass %, inclusive, and a thickness of the chocolate bar is between 1 mm and 2 mm, inclusive.
(2) The chocolate bar according to (1) having a mass of between 2 g and 6 g, inclusive, per bar.

### Advantageous Effects of Invention

According to the present invention, in the chocolate having a cacao mass content of 35 mass % or more, the bitterness and astringency can be reduced by adding a predetermined amount of sucrose palmitate and adjusting the chocolate to have a predetermined thickness.

### DESCRIPTION OF EMBODIMENTS

Hereafter, embodiments to carry out the present invention are described in detail.

The chocolate bar of the present invention contains 35 mass % or more of a cacao mass based on a total mass of the chocolate bar. Chocolates having a cacao mass content below 35 mass % do not have an intense bitterness or astringency, hence not the object to be solved by the present invention. It is preferable that a cacao mass content be 60 mass % or more since the reducing effect on the chocolate bitterness and astringency of the present invention is notably demonstrated. Ingredients other than the cacao mass may be those used for producing the common chocolates such as sugars, milk powders, cocoa butters, vegetable oils and fats, lecithin and flavors. The moisture content in the chocolate bar of the present invention is not particularly limited but preferably 3 mass % or less and more preferably 2 mass % or less based on a total mass of the chocolate bar. A moisture content in such a range is preferable because it provides the chocolate bar with a suitable hardness and achieves a superior snap.

The chocolate bar of the present invention comprises the combination of a predetermined sucrose palmitate content and a predetermined thickness thereof. More specifically, (1) when a sucrose palmitate content is between 0.2 mass % and 0.5 mass %, inclusive, based on a total mass of the chocolate bar, a thickness of the chocolate bar is between 1 mm and 3 mm, inclusive, or (2) when a sucrose palmitate content is between 0.1 mass % and 0.5 mass %, inclusive, based on a total mass of the chocolate bar, a thickness of the chocolate bar is between 1 mm and 2 mm, inclusive. Thus, the reducing effect on the bitterness and astringency can be remarkably enhanced by the synergistic effect of including the sucrose palmitate in the chocolate and thinning the thickness of the chocolate.

In the chocolate bar of the present invention, the viscosity of the chocolate in a melted state hardly changes even when sucrose palmitate is added. For this reason, the workability such as easily molding the chocolate in a melted state into a thin shape is assured. Meanwhile, sucrose palmitate when contained in the chocolate bar of the present invention can achieve the reducing effect on the bitterness and astringency caused by a high cacao mass content and the strength of the chocolate bar after solidified can be increased. The HLB value of sucrose palmitate contained in the chocolate bar of the present invention is not particularly limited and preferably 10 to 19 and more preferably 14 to 18. With HLB values in such a range, the reducing effect on the bitterness and astringency of the present invention is easily demonstrated.

The chocolate bar of the present invention has a thickness of between 1 mm and 3 mm, inclusive, or between 1 mm and 2 mm, inclusive. The typical chocolate bars have a thickness of about 5 mm at the thinnest. Generally, when a chocolate bar is thinner than 5 mm, it is difficult to provide a hardness accordingly failing to achieve a superior snap. The chocolate bar of the present invention, when containing a predetermined amount of sucrose palmitate, can increase the strength after solidified thereby being thinner than the common chocolate bars.

The method for producing the chocolate may be those used for producing the common chocolates. For example, some of the chocolate ingredients are mixed, ground using a refiner roll and the like, and subsequently conched and the remaining chocolate ingredients are fed, followed by further mixing to obtain a chocolate in a melted state. Sucrose palmitate may be added at any stage of the production steps but is preferably added after the refiner roll treatment because the chocolate ingredients mixture is more efficiently crushed with a refiner roll than added before the refiner roll treatment.

Then, the chocolate in a melted state is molded into a predetermined shape, cooled and solidified to obtain the final product. During this operation, the molding is carried out to obtain the thickness of between 1 mm and 3 mm, inclusive, or between 1 mm and 2 mm, inclusive. It is preferable that a mass be between 2 g and 6 g, inclusive, per bar. Thus, the reducing effect on the bitterness and astringency of the present invention is easily demonstrated while the chocolate flavor is maintained. The method for molding the chocolate in a melted state into a predetermined shape is not particularly limited. The melted chocolate may be injected into a mold of predetermined shape, cooled, solidified and subsequently detached or may be molded into a large chocolate bar having a thickness of between 1 mm and 3 mm, inclusive, or between 1 mm and 2 mm, inclusive, using a stencil and the like, solidified and subsequently cut in to achieve a predetermined mass.

In an embodiment of the present invention, the shape of a chocolate is bar form but may be curved or bent, or may even have for example, a hemispherical or box-shaped shell structure. In this instance, the thickness of the wall forming the shell may be between 1 mm and 3 mm, inclusive, or between 1 mm and 2 mm, inclusive. The chocolate bar surface may be adorned with patterns and projections as long as the effect of the present invention can be provided. In this instance, the thickness of the thinnest part of the chocolate may be between 1 mm and 3 mm, inclusive, or between 1 mm and 2 mm, inclusive.

A B-type viscometer is used for the viscosity measurement of the chocolate. The viscosity is calculated from the stress imposed when a No. 6 rotor is rotated at 4 rpm in a melted chocolate at a product temperature of 40° C.

### EXAMPLES

Hereinafter, the embodiments of the present invention are further described in detail with reference to Examples but the present invention is not limited thereto.

### Production Example 1

A chocolate dough (chocolate ingredients mixture) was obtained by a routine method using 25 mass parts of a sugar, 64 mass parts of a cacao mass, 5 mass parts of a cocoa powder, 4.5 mass parts of a cocoa butter, 0.5 mass parts of lecithin and 1 mass part of a flavor. 99.5 Mass parts of the obtained chocolate dough and 0.5 mass parts of sucrose palmitate were mixed to obtain a sucrose palmitate-containing chocolate dough.

### Test Example 1

The obtained sucrose palmitate-containing chocolate dough was tempered in accordance with a routine method, 4 g of which was injected to each of the molds of various sizes to mold chocolate bars of different thicknesses.

The sizes of the obtained chocolate bars are shown in Table 1. The overall quality of each of the chocolates when consumed was evaluated with the aroma, bitterness and astringency of the chocolate as indicators, according to the following scale: A: Very desirable, B: Desirable, C: somewhat desirable, D: somewhat undesirable, E: Undesirable and F: Very undesirable.

TABLE 1
Shape and quality evaluation of chocolates

| | Shape | | | |
|---|---|---|---|---|
| | Length | | Thickness | Quality |
| Test plot | (mm) | Width (mm) | (mm) | evaluation |
| Example 1 | 60.00 | 28.50 | 1.20 | A |
| Example 2 | 43.00 | 43.00 | 2.88 | A |
| Comparative | 38.00 | 40.00 | 3.39 | B |
| Example 1 | | | | |
| Comparative | 34.00 | 18.00 | 5.39 | D |
| Example 2 | | | | |
| Comparative | 43.00 | 22.00 | 6.00 | E |
| Example 3 | | | | |
| Comparative | 12.00 | 12.00 | 10.00 | F |
| Example 4 | | | | |

### Example 1

When put in the mouth, the chocolate had an aroma and the aftertaste had little bitterness and little astringency thereby providing a very desirable quality.

### Example 2

When put in the mouth, the chocolate had an aroma and the aftertastes had little bitterness and little astringency thereby providing a very desirable quality.

### Comparative Example 1

When put in the mouth, the chocolate had a slight aroma and the aftertastes had slightly little bitterness and slightly little astringency thereby providing a desirable quality.

### Comparative Example 2

When put in the mouth, the chocolate had a slightly weak aroma and the aftertastes had slightly intense bitterness and slightly intense astringency thereby providing a somewhat undesirable quality.

### Comparative Example 3

When put in the mouth, the chocolate had a weak aroma and the aftertastes had intense bitterness and intense astringency thereby providing an undesirable quality.

### Comparative Example 4

When put in the mouth, the chocolate had a weak aroma and the aftertastes had very intense bitterness and astringency thereby providing a very undesirable quality.

### Test Example 2

Chocolate bars each having a different sucrose palmitate content and chocolate thickness were produced and evaluated for the quality and strength. The quality points present the evaluation results on the total quality. The evaluation was conducted according to the following 10-point scale: 10=the most desirable quality to 1=the most undesirable quality.

The strength measurement was carried out using a rheometer (model name: RTC-301 D-CW, manufactured by FUDOH), and the maximum stress at which a 3 mm diameter-cylindrical plunger was advanced at a speed of 20 mm/second until the chocolate bar broke was defined as the strength. The results are shown in Table 2 and Table 3. The relative strengths, when the strength of the chocolate bar at the time of not adding sucrose palmitate was defined as 1, were shown in Table 4. The chocolate doughs used and the viscosity of sucrose palmitate-containing chocolate doughs are shown in Table 5.

TABLE 2
Chocolate thickness, sucrose palmitate content and quality

| Thickness | | Sucrose palmitate content (mass %) | | | |
|---|---|---|---|---|---|
| (mm) | | 0.0% | 0.1% | 0.2% | 0.5% |
| 1.20 | Evaluation | Not so astringent. | Not astringent. | Not astringent. | Least astringent. |
| | | Slightly astringent | Weak bitterness. | Weak bitterness. | Weak bitterness. |
| | | aftertaste. | | | |
| | Point | 6 | 7 | 9 | 10 |
| 2.88 | Evaluation | Bitter, astringent. | Bitter, astringent. | Not astringent. | Not astringent. |
| | | Heavy aftertaste. | Heavy aftertaste. | Weak bitterness. | Weak bitterness. |
| | | | Weak astringency | | |
| | | | moderating effect. | | |
| | Point | 4 | 6 | 8 | 9 |
| 3.39 | Evaluation | Bitter, astringent. | Bitter, astringent. | Not astringent. | Not astringent. |
| | | Heavy aftertaste. | Heavy aftertaste. | Weak bitterness. | Weak bitterness. |
| | Point | 4 | 5 | 8 | 9 |
| 5.39 | Evaluation | Bitter, astringent. | Bitter, astringent. | Bitter, astringent. | Not astringent. |
| | | Heavy aftertaste. | Heavy aftertaste. | Heavy aftertaste. | Weak bitterness. |
| | Point | 3 | 4 | 6 | 8 |
| 6.00 | Evaluation | Bitter, astringent. | Bitter, astringent. | Bitter, astringent. | Not astringent. |
| | | Heavy aftertaste. | Heavy aftertaste. | Heavy aftertaste. | Weak bitterness. |
| | Point | 3 | 4 | 6 | 7 |
| 10.00 | Evaluation | Bitter, astringent. | Bitter, astringent. | Bitter, astringent. | Bitter, astringent. |
| | | Heavy aftertaste. | Heavy aftertaste. | Heavy aftertaste. | Heavy aftertaste. |
| | Point | 2 | 3 | 5 | 6 |

TABLE 3
Chocolate strength (Unit: kgf)

Sucrose palmitate
content (mass %)

| Thickness (mm) | 0.0% | 0.1% | 0.2% | 0.5% |
|---|---|---|---|---|
| 1.20 | 0.89 | 1.16 | 1.23 | 1.50 |
| 2.88 | 3.19 | 3.31 | 3.51 | 4.10 |
| 3.39 | 4.39 | 3.55 | 4.01 | 4.09 |
| 5.39 | 5.76 | 5.81 | 6.12 | 6.33 |
| 10.00 | 7.33 | 7.41 | 6.93 | 7.21 |

TABLE 4
Chocolate relative strength

| Thickness (mm) | 0.0% | 0.1% | 0.2% | 0.5% |
|---|---|---|---|---|
| 1.20 | 1.00 | 1.31 | 1.39 | 1.69 |
| 2.88 | 1.00 | 1.04 | 1.10 | 1.29 |
| 3.39 | 1.00 | 0.81 | 0.91 | 0.93 |
| 5.39 | 1.00 | 1.01 | 1.06 | 1.10 |
| 10.00 | 1.00 | 1.01 | 0.95 | 0.98 |

TABLE 5
Chocolate dough viscosity

| Sucrose palmitate content | |
|---|---|
| (mass %) | Viscosity (CPS) |
| 0 | 29500 |
| 0.1 | 29750 |
| 0.2 | 30250 |
| 0.5 | 31750 |

The chocolate bars having a thickness of 1.20 mm and 2.88 mm had notably increased strengths as the sucrose palmitate content increased. However, the chocolate bars having a thickness greater than 3 mm did not have significant increases in the strengths by sucrose palmitate. Additionally, the viscosity increase of the chocolate dough was 7.6% when 0.5 mass % of sucrose palmitate was added.

When the chocolate bars molded to have a thickness of 1.20 mm was consumed, the chocolate bars to which 0.5 mass % of sucrose palmitate was added had a desirable texture with a superior snap as a chocolate bar compared with the chocolate bars to which sucrose palmitate was not added.

Various emulsifier-containing chocolates were produced with the same formulation as Production Example 1, except that sucrose palmitate was replaced with another emulsifier, and molded into a square bar form each sized to have a length of 20 mm, a width of 20 mm and a thickness of 2 mm.

The obtained chocolate bars were each evaluated for the bitterness, astringency and quality. The reducing effects on the bitterness and astringency were evaluated according to the following scale: 4=very effective to 1=not effective. The results are shown in Table 6.

TABLE 6
Reducing effects of different emulsifiers on bitterness and astringency

| Test plot | Sample names | Maker | HLB | Composition | Evaluation | Comment |
|---|---|---|---|---|---|---|
| Comparative | Sunsoft | Taiyo | 15.5 | Decaglycerol | 1 | Heavy taste in the middle. |
| Example 5 | Q-12S | Kagaku Co., | | monolaurate | | Bitterness diminished |
| | | Ltd. | | | | thereafter, slighly left in the |
| | | | | | | end but the aroma was also |
| | | | | | | slighly left in the end. |
| Comparative | Sunsoft | Taiyo | 14.5 | Decaglycerol | 1 | Lighter taste than Comparative |
| Example 6 | Q-14S | Kagaku Co., | | monomyristate | | Example 5. Weak flavor. |
| | | Ltd. | | | | Sourness tends to be noted. |
| Comparative | Sunsoft | Taiyo | 12 | Decaglycerol | 3 | More favorable aroma than |
| Example 7 | Q-17S | Kagaku Co., | | monooleate | | Comparative Examples 5 and |
| | | Ltd. | | | | 6. Less bitter than Control. |
| | | | | | | Slight bitterness lingered but |
| | | | | | | light taste. |
| Comparative | Sunsoft | Taiyo | 12 | Decaglycerol | — | Not evaluated. |
| Example 8 | Q-18S | Kagaku Co., | | monostearate | | |
| | | Ltd. | | | | |
| Comparative | Sunsoft | Taiyo | 14 | Pentaglycerol | 1 | Astringent from the middle to |
| Example 9 | A-121E | Kagaku Co., | | monolaurate | | the end. More astringent than |
| | | Ltd. | | | | Comparative Examples 5, 6 |
| | | | | | | and 1. |
| Comparative | Sunsoft | Taiyo | 13 | Pentaglycerol | 1 | Astringent with no aroma. |
| Example 10 | A-141E | Kagaku Co., | | monomyristate | | As astringent as Comparative |
| | | Ltd. | | | | Example 8. |
| Comparative | Sunsoft | Taiyo | 13 | Pentaglycerol | 3 | Substantially no bitterness or |
| Example 11 | A-171E | Kagaku Co., | | monooleate | | astringency but had an aroma |
| | | Ltd. | | | | in good balance. Light taste. |
| | | | | | | A sharp finish |
| Comparative | Sunsoft | Taiyo | 13 | Pentaglycerol | — | Not evaluated due to the |
| Example 12 | A-181E | Kagaku Co., | | monostearate | | spherical emulsifier particles. |
| | | Ltd. | | | | |
| Comparative | Sunsoft | Taiyo | 8.5 | Diglycerol | 2 | Dissolved well but had a |
| Example 13 | Q-12D | Kagaku Co., | | monolaurate | | bitterness. |
| | | Ltd. | | | | |
| Comparative | RYOTO Sugar | Mitsubishi- | 16 | Sucrose | 3 | Slightly astringent but |
| Example 14 | Ester S1670 | Kagaku Foods | | stearate | | dissolved well. |
| | | Corporation | | | | |
| Example 3 | RYOTO Sugar | Mitsubishi- | 16 | Sucrose | 4 | Very light taste, dissolved |
| | Ester P1670 | Kagaku Foods | | palmitate | | quickly and well. |
| | | Corporation | | | | |
| Comparative | RYOTO Sugar | Mitsubishi- | 16 | Sucrose | 1 | Very intense astringency. |
| Example 15 | Ester M1695 | Kagaku Foods | | myristate | | Dissolved slowly. |
| | | Corporation | | | | |
| Comparative | RYOTO Sugar | Mitsubishi- | 1 | Sucrose | 1 | Dissolved slowly. |
| Example 16 | Ester O170 | Kagaku Foods | | oleate | | |
| | | Corporation | | | | |
| Comparative | RYOTO Sugar | Mitsubishi- | 16 | Sucrose | 1 | Molded afterward. Sensed a |
| Example 17 | Ester L1695 | Kagaku Foods | | laurate | | bitterness. Hardly dissolved. |
| | | Corporation | | | | |
| Comparative | None | — | — | — | 2 | Control |
| Example 18 | | | | | | |

The chocolates containing decaglycerol monooleate, pentaglycerol monooleate or sucrose palmitate had suppressed bitterness and astringency with good aroma, hence were desirable. The chocolates particularly containing sucrose palmitate had a very refreshing quality, hence were particularly desirable.

The chocolate doughs produced using chocolate doughs each having a different cacao mass content by the method as in Production Example 1, to some of which sucrose palmitate was added and to some other of which sucrose palmitate was not added, were each molded into a 2.6 mm-thickness bar form, solidified and subsequently consumed to compare the qualities thereby evaluating the reduction of the bitterness and astringency when sucrose palmitate was added. Table 7 shows the chocolates used and Table 8 shows the results of quality evaluation. The reducing effects of the emulsifiers on the bitterness and astringency were evaluated according to the following scale: A: Notably effective, B: Effective, C: Slightly effective and D: Not effective.

TABLE 7
Chocolate formulation

| | Example | Example | Example | Example | Comparative | Comparative | Comparative |
|---|---|---|---|---|---|---|---|
| Ingredients | 4 | 5 | 6 | 7 | Example 17 | Example 18 | Example 19 |
| Sugar | 1.6 | 10.8 | 25.2 | 43.9 | 42.1 | 33.7 | 35.0 |
| Cacao mass | 87.0 | 73.2 | 64.7 | 37.0 | 22.4 | 13.2 | — |
| Cocoa powder | 10.8 | 12.0 | 5.0 | — | — | — | — |
| Cocoa butter | — | 3.3 | 4.4 | 0.5 | 16.8 | 11.7 | 21.5 |
| Vegetable fats and oils | — | — | — | 13.8 | — | 11.6 | 10.1 |
| Whole milk powder | — | — | — | 4.2 | 18.1 | 25.2 | 31.0 |
| Defatted milk powder | — | — | — | — | — | 4.0 | 1.7 |
| Lecithin | 0.5 | 0.5 | 0.5 | 0.5 | 0.5 | 0.5 | 0.6 |
| Flavor | 0.1 | 0.2 | 0.2 | 0.1 | 0.1 | 0.1 | 0.1 |
| Total | 100.0 | 100.0 | 100.0 | 100.0 | 100.0 | 100.0 | 100.0 |

TABLE 8
Main components of chocolate doughs

| | Cacao mass | Whole milk | Defatted milk | | |
|---|---|---|---|---|---|
| | amount | powder content | powder content | Oil content | Reducing effect on |
| Test plot | (mass %) | (mass %) | (mass %) | (mass %) | bitterness and astringency |
| Example 4 | 87.0 | 0.0 | 0.0 | 51.0 | A |
| Example 5 | 73.2 | 0.0 | 0.0 | 46.0 | A |
| Example 6 | 64.7 | 0.0 | 0.0 | 41.5 | A |
| Example 7 | 37.0 | 4.3 | 0.0 | 36.5 | C |
| Comparative | 22.4 | 18.0 | 0.0 | 34.5 | D |
| Example 17 | | | | | |
| Comparative | 13.2 | 25.2 | 0.0 | 38.0 | D |
| Example 18 | | | | | |
| Comparative | 0.0 | 31.5 | 1.7 | 40.0 | D |
| Example 19 | | | | | |

The chocolates having a cacao mass content of 64.7 mass % or more demonstrated notable reduction in the chocolate bitterness and astringency by the addition of sucrose palmitate. The chocolates having a cacao mass content of 37 mass % also demonstrated to be effective. However, the chocolates having a cacao mass content of 22.4 mass % or less demonstrated no effect when sucrose palmitate was added.

1. A chocolate bar containing sucrose palmitate and having a cacao mass content of 35 mass % or more, wherein
(i) a sucrose palmitate content is between 0.2 mass % and 0.5 mass %, inclusive, and a thickness of the chocolate bar is between 1 mm and 3 mm, inclusive, or
(ii) a sucrose palmitate content is between 0.1 mass % and 0.5 mass %, inclusive, and a thickness of the chocolate bar is between 1 mm and 2 mm, inclusive.

2. The chocolate bar according to claim 1 having a mass of between 2 g and 6 g, inclusive, per bar.
